(19) United States
(12) Patent Application Publication
(10) Pub. No.: US 2016/0306612 A1
(43) Pub. Date: Oct. 20, 2016

(54) DETERMINING ERRORS AND WARNINGS CORRESPONDING TO A SOURCE CODE REVISION

(71) Applicant: International Business Machines Corporation, Armonk, NY (US)

(72) Inventors: James Hewitt, Eastleigh (GB); Colin I. Holyoake, Winchester (GB); Richard Postlethwaite, Salisbury (GB); Caroline J. Thomas, Eastleigh (GB)

(21) Appl. No.: 15/076,763

(22) Filed: Mar. 22, 2016

Related U.S. Application Data
(63) Continuation of application No. 14/685,679, filed on Apr. 14, 2015.

(51) Int. Cl. G06F 9/44; G06F 11/36

(52) U.S. Cl. CPC G06F 8/33; G06F 11/3616

(57) ABSTRACT

The method of tracking errors and warnings of a revision of source code includes a computer processor that receives a first and second revision of source code. The computer processor determines a first set of errors and warnings included in the first revision of the source code and a second set of errors and warnings included in the second revision of the source code. The computer processor identifies a third set of errors and warnings that appear in the first revision of the source code, and absent in the second revision of the source code, and the computer processor identifies a fourth set of errors and warnings that are absent in the first revision of the source code and that appear in the second revision of the source code.

### BACKGROUND

The present invention relates generally to the field of software testing, and more particularly to determining a revision associated with particular errors and warnings of code editing in an Integrated Development Environment.

Software code may be updated for a variety of reasons, for example, discovered errors, performance improvements, compatibility issues, or correcting security exposures. The code changes and updates are also known as patches, commits, or revisions, hereafter collectively referred to as revisions. When a developer edits software code in an Integrated Development Environment (IDE), the IDE will identify errors and warnings during compiling of the code, and display the errors and warnings to a developer in a view as a result of altering the code. By editing source code, a change in one file may produce errors and warnings in another file. Typically, on projects containing a large volume of code created by numerous developers on different development teams, each team may have different standards that determine which errors and warnings are important and are to be corrected, leading to a possibility of source code having hundreds or thousands of errors and warnings. When a view of the errors and warnings lists a copious number of errors and warnings, developers may be unable to distinguish new errors and warnings from old ones. Without the aide of an effective errors and warnings view, a developer is much more likely to unknowingly fail to correct new errors and warnings that have been introduced, and may prevent a timely and efficient completion of the project.

### SUMMARY

According to one embodiment of the present invention, a method, computer program product, and a computer system for tracking errors and warnings associated with a revision of source code is provided. The method for tracking errors and warnings associated with a revision of source code includes one or more computer processors that receive a first revision of a source code and a second revision of the source code, in which the second revision follows the first revision of the source code. One or more computer processors determine a first set of errors and warnings included in the first revision of the source code. One or more computer processors determine a second set of errors and warnings included in the second revision of the source code. One or more computer processors identify a third set of errors and warnings that includes errors and warnings that appear in the first revision of the source code, and are absent in the second revision of the source code, and one or more computer processors identify a fourth set of errors and warnings that are absent in the first revision of the source code and that appear in the second revision of the source code.

### BRIEF DESCRIPTION OF THE DRAWINGS

FIG. 1 is a functional block diagram illustrating a distributed computer processing environment, in accordance with an embodiment of the present invention.

FIG. 2 is a functional block diagram illustrating an operational process workflow of a code changes program, operating on a computing device within the distributed computing environment of FIG. 1, in accordance with an embodiment of the present invention.

FIG. 3 is a functional block diagram illustrating an operational process workflow of a code changes program that determines a revision to which an error or warning corresponds, operating on a computing device within the distributed computing environment of FIG. 1, in accordance to an embodiment of the present invention.

FIG. 4 is a functional block diagram illustrating an operational process workflow of a code changes program for annotating revision history with error and warning information, operating on a computing device within the distributed computing environment of FIG. 1, in accordance to an embodiment of the present invention.

FIG. 5 depicts a block diagram of components of a computing device capable of performing the operational workflow processes of the code changes program, in accordance with an embodiment of the present invention.

### DETAILED DESCRIPTION

Some embodiments of the present invention recognize that an errors and warnings view within an IDE may contain copious amounts of errors and warnings that accrued during the development of a project containing a large volume of code. As these errors and warnings accumulate, the errors and warnings view of the IDE becomes fairly useless because a developer is unable to distinguish new errors and warnings from old ones, allowing a developer to unknowingly introduce more errors and warnings into the project. By unknowingly creating additional errors and warnings to the existing large volume of existing errors and warnings, a developer does not realize the new errors and warnings to be fixed and adds to the technical debt of the project, preventing a timely and efficient completion of the project.

Embodiments of the present invention address a solution for determining errors and warnings during the development of a project, locating the change that introduced an error or warning, and annotating the repository history with error and warning information. For brevity and convenience, embodiments of the present invention referring to errors and warnings, hereafter, collectively refer to at least, but not limited to, errors and warnings resulting from code development, markers, or other tagging mechanisms for documenting code, for example, TODO or FIXME. Embodiments of the present invention determine the revision corresponding to an error or warning generated during code development, and provide annotation of revision history with error and warning information, as described further below, with reference to the Figures.

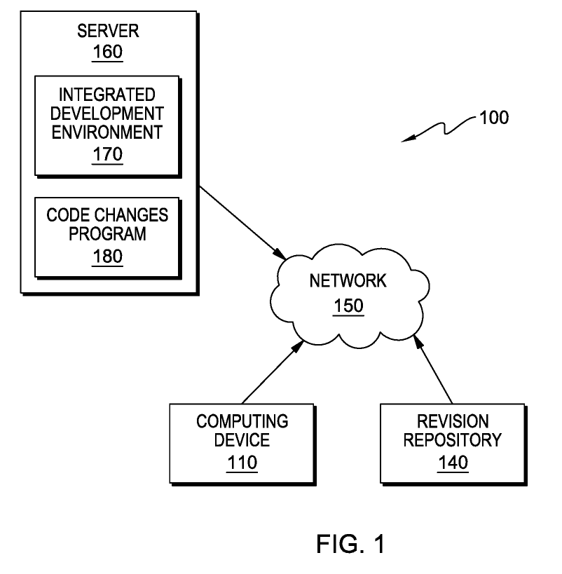

FIG. 1 is a functional block diagram illustrating distributed computer processing environment 100. FIG. 1 provides only an illustration of one implementation, and does not imply any limitations with regard to the environments in which different embodiments are implemented. Many modifications to the depicted environment can be made by those skilled in the art without departing from the scope of the invention as recited by the claims.

Distributed computer processing environment 100 includes server 160, which operates integrated development environment 170 and code changes program 180. Also included in distributed computer processing environment 100 is computing device 110 and revision repository 140. Computing device 110, server 160, and revision repository 140 are all interconnected through network 150.

Network 150 can be, for example, a local area network (LAN), a telecommunications network, a wide area network (WAN), such as the Internet, a virtual local area network (VLAN), or any combination that can include wired, wireless, or fiber optic connections. In general, network 150 can be any combination of connections and protocols that will support communications between computing device 110, revision repository 140, server 160, and other components (not shown) of distributed computer processing environment 100, in accordance with embodiments of the present invention.

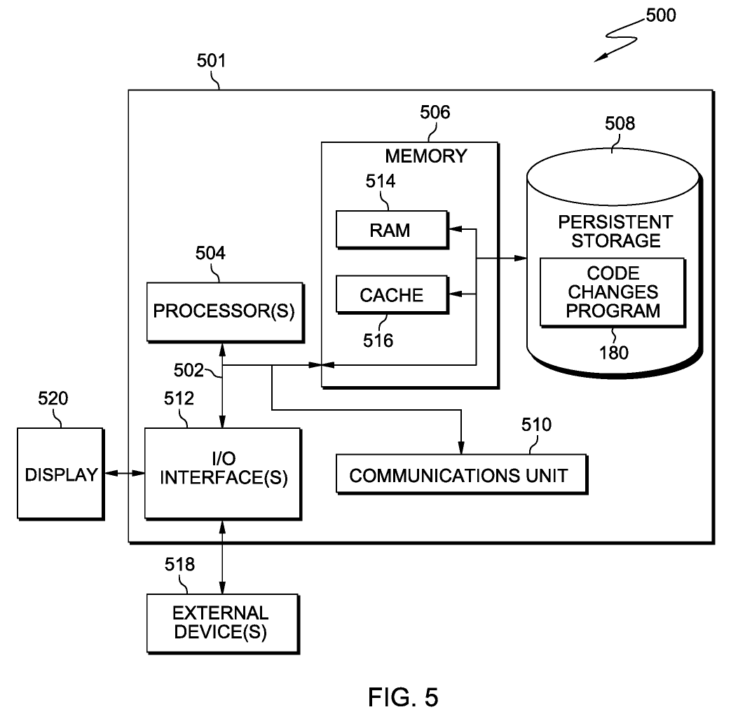

Computing device 110 may be operated by a user, such as a developer. In some embodiments of the present invention, computing device 110 includes integrated development environment 170 as a common means for developers to directly access an IDE. In other embodiments, computing device 110 accesses integrated development environment 170 hosted on server 160 via network 150. Computing device 110 may be a laptop computer, a desktop computer, a tablet computer, a netbook computer, a personal computer (PC), a mobile computing device, or any programmable electronic device or computing system capable of receiving and sending data and performing computer readable program instructions capable of operating integrated development environment 170 and communicating with server 160 via network 150. In other embodiments, computing device 110 can represent virtual instances operating on a computing system utilizing clustered computers and components (e.g., database server computer, application server computers, etc.) that act as a single pool of seamless resources when accessed within distributed computer processing environment 100. Computing device 110 may include internal and external hardware components, as depicted and described further with reference to FIG. 5.

Revision repository 140 includes capability for storing multiple source code revisions of code developed and edited from integrated development environment 170. In some embodiments of the present invention, users of integrated development environment 170 access revision repository 140 to retrieve revisions of source code. For example, a user of computing device 110, which is hosting integrated development environment 170 (not shown), accesses revision repository 140 located on server 160, via network 150, to retrieve a current revision of source code. In another embodiment, a user of computing device 110 accesses integrated development environment 170 hosted on server 160, via network 150. Through integrated development environment 170, the user may access revision repository 140 and retrieve a current or previous revision of source code, and use code changes program 180 to identify errors and warnings in source code to determine the source code revision in which the errors and warnings were introduced. In some embodiments of the present invention, revision repository 140 contains all available revisions of the source code. In other embodiments source code revisions are distributed across more than one storage location (not shown). For example, revision repository 140 resides on computing device 110, and half the available revisions of an application's source code are stored in revision repository 140, whereas the other half of available revisions are included in a separate revision repository located on server 160, which is connected to network 150.

In some embodiments of the present invention, revision repository 140 can be one of, a web server, a mobile computing device, a laptop computer, a tablet computer, a netbook computer, a personal computer (PC), a desktop computer, or any programmable electronic device or computing system capable of receiving, storing, and sending files and data, and performing computer readable program instructions capable of communicating with server 160 and computing device 110 via network 150. In other embodiments, revision repository 140 can represent virtual instances operating on a computing system utilizing clustered computers and components (e.g., database server computer, application server computers, etc.) that act as a single pool of seamless resources when accessed within distributed computer processing environment 100. Revision repository 140 may include internal and external hardware components, as depicted and described further with reference to FIG. 5.

Server 160 is a web-based server included in distributed computer processing environment 100. Server 160 is depicted as including integrated development environment 170 and operational access of code changes program 180, in accordance with an embodiment of the present invention. Server 160 receives content from users that access integrated development environment 170 via network 150. For example, a user may access content of integrated development environment 170 by connecting to server 160 and logging into integrated development environment 170. Server 160 may access content for code changes program 180 from revision repository 140 via network 150. In some embodiments of the present invention, integrated development environment 170 can operate on local computing devices, such as computing device 110, accessing revisions locally or from revision repository 140 via network 150. In other embodiments, integrated development environment 170 can be hosted on a web-based server and accessed by a local computing device, such as computing device 110.

In some embodiments of the present invention, server 160 is a web-based server of distributed computer processing environment 100, and is depicted as hosting code changes program 180, in accordance with an embodiment of the present invention. In other embodiments, code changes program 180 may reside locally on computing device 110, for example (not shown). Server 160 can be a web server, a blade server, a mobile computing device, a laptop computer, a tablet computer, a netbook computer, a personal computer (PC), a desktop computer, or any programmable electronic device or computing system capable of receiving and sending data via network 150, and performing computer-readable program instructions. In another embodiment, server 160 represents a computing system utilizing clustered computers and components (e.g., database server computer, application server computers, etc.) that act as a single pool of seamless resources, such as in a cloud computing environment, when accessed within distributed computer processing environment 100. Server 160 may include internal and external hardware components, as depicted and described with reference to FIG. 5.

Code changes program 180 is depicted as being hosted on server 160, and is accessible by computing device 110 via network 150. In some embodiments of the present invention, code changes program 180 may be hosted locally on computing device 110 (not shown). Code changes program 180 is an application that includes three operational workflows, one of which identifies errors and warnings that correspond to a particular revision of source code, based on comparison between errors, warnings, and assoicated attributes of the particular revision and errors, warnings, and assoicated attributes of an adjacent revision. In one embodiment of the present invention, code changes program 180 determines base errors and warnings made to source code files. Base errors and warnings are the errors and warnings generated in the initial release of source code. Code changes program 180 maps the location of the base errors and warnings in the source code files. Having mapped the base errors and warnings, code changes program 180 determines errors and warnings of the current revision of code in which the current revision is the most recent revision, and compares the differences between the errors and warnings of the base revision and the current revision. Code changes program 180 displays differences between the current and base revisions.

In another embodiment of the present invention, a second operational workflow of code changes program 180 determines the revision in which an error or warning was introduced in the source code. When an error or warning is selected from a current revision, code changes program 180 loads a previous revision to determine if the error or warning is within the previous revision. If the error or warning is not within the previous revision, code changes program 180 loads the next previous revision to determine if the error or warning is within the next previous revision. Code changes program 180 searches the next previous revisions until the selected error or warning is no longer found in the examined revision. Having determined the previous revision in which the selected error or warning is not found, code changes program 180 displays the currently selected revision as the revision that introduced the selected error or warning.

In yet another embodiment of the present invention, the third operational workflow of code changes program 180 adds annotation to the repository history with errors and warnings information for a particular revision. Repository history may be annotated by code changes program 180 by comparing the errors and warnings of the initial release of source code, referred to herein as the first revision, to the errors and warnings of the next subsequent revision. In another embodiment, revision history may be annotated by comparing the errors and warnings of the most recent revision, as the base code, to the errors and warnings of the previous revision. For brevity and convenience, embodiments of the present invention refer to annotating the repository history by starting with the initial source code, referred to as the first repository revision, and comparing the first repository revision to a subsequent or next revision; however, it is noted that either approach makes use of techniques disclosed herein.

Code changes program 180 receives a first revision from revision repository 140. Having received the first repository revision, code changes program 180 determines the base errors and warnings of the first repository revision, and a next revision is selected. Code changes program 180 determines the new errors and warnings of the next revision, and by comparing the first revision and the next revision, determines the error and warning differences between them. Having determined the differences, code changes program annotates the next revision with error and warning information. If there are more revisions to annotate, code changes program 180 selects the next subsequent revision and repeats the process of determining error and warning differences between revisions, as described above. In some embodiments of the present invention, in response to determining that there are no additional revisions to annotate, code changes program 180 displays the error and warning information, for example, in a history view of revisions within an integrated development environment. In other embodiments, the error and warning annotation information associated with each revision of source code is stored until a request to access the information is received. Embodiments using code changes program 180 will be described in more detail below.

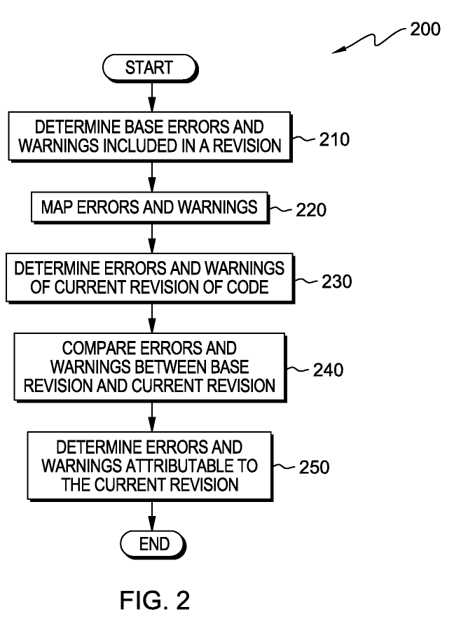

FIG. 2 is a functional block diagram illustrating operational workflow 200 of code changes program 180, operating on server 160 within distributed computer processing environment 100 of FIG. 1, in accordance with an embodiment of the present invention.

In some embodiments of the present invention discussed herein, code changes program 180 is initiated by a computing device, such as computing device 110, accessing integrated development environment 170 hosted on server 160 via network 150. Additionally, code changes program 180 may access revision repository 140 via network 150, in order to store and retrieve source code error and warning information of program revisions made in integrated development environment 170.

In an embodiment of the present invention, to distinguish new errors and warnings during development and editing of a code revision, code changes program 180 determines base errors and warnings included in a revision (step 210) from changes made to the source code. In some embodiments of the present invention, the revision of source code is referred to as a base revision and, in the following discussion, the base revision is further modified and edited, resulting in a current revision. Stated differently, the base revision adjacently precedes the current revision. A compiler or another static code analysis tool generates error, warning, or other marker information, for example, but not limited to, a line or set of characters positioned to align with location of the error, warning, or other information, which are contained in the compiled source code. In some embodiments of the present invention, code changes program 180 determines other tagging mechanisms, such as TODO or FIXME, and annotations in source code revision files but, for brevity and convenience, embodiments of the present invention, hereafter, refer to errors, warnings, marker information, and code documentation, collectively, as errors and warnings of revisions of the source code. Code changes program 180 identifies the base errors and warnings included in the revision of source code using the attributes associated with the revision, such as the source file name, line number, character position within the line number, an identification code of the error, a label of the error, or an annotation as a description of the code's activity corresponding to the error or warning as identifying text. Code changes program 180 may determine base errors and warnings using a combination of the error or warning, and other information attributes associated with the error or warning. In some embodiments of the present invention, code changes program 180 stores the errors and warnings of a revision in revision repository 140, whereas in other embodiments, the identified errors and codes of a revision may be stored locally by code changes program 180.

In some embodiments of the present invention, the base revision is accessed by a developer and further modified and edited, resulting in a new, most recent revision of the source code, referred to herein as the current revision.

Having identified the errors and warnings of the base revision, code changes program 180 maps the base errors and warnings (step 220). Code changes program 180 maps the base errors and warning by comparing the base source code stored in revision repository 140 and the current revision of the base source code to determine how the files changed. By use of the information attributes associated with the identified errors and warnings of the base revision, code changes program 180 determines an approximate location mapping of the errors and warnings within the base revision. As changes are made to the base revision, during development activity of the current revision, code changes program 180 uses the mapping data of base errors and warnings and applies the line additions, line removals, and code edits to determine an expected location of a previously existing error or warning. Code changes program 180 determines if the position of an error or warning of the base revision may be affected by modifications made during generation of the current revision, and records the base errors and warnings along with their new expected locations within the current revision. A file difference generator, such as a diff utility, may be used to compare and determine differences between sources of text. To create a map of the base errors and warnings, the new expected locations of the base source code are tagged or marked to be identified as “previous errors and warnings,” for example. Code changes program 180 includes information regarding the expected locations of the old errors and warnings of the base revision, as they will appear in the error and warning information associated with the current revision which code changes program 180 stores in revision repository 140.

A compiler or another static code analysis tool generates error, warning, or other code tagging information, and code changes program 180 determines errors and warnings of the current revision of code (step 230). In some embodiments of the present invention, code changes program 180 determines other tagging mechanisms, for example, the use of labels or markers such as TODO or FIXME, and other annotations in source code files. Code changes program 180 determines errors and warnings of the current revision of code by distinguishing the attribute information of each error and warning generated in the current revision. An attribute of an error or warning may include a source file, line number, character number within its line number, an identification of the error, or an annotation describing the code's activity corresponding to the error or warning identifying text. Code changes program 180 may determine errors and warnings of a current revision of code by using a combination of the error, warning, or other information attributes. Errors and warnings of the current revision may be labeled as “new errors and warnings,” for example. Code changes program 180 stores the new errors and warnings of the current revision in revision repository 140, along with their corresponding information, such as the location of the errors and warnings within the current revision.

Code changes program 180 compares the errors and warnings between the base revision and the current revision (step 240). By comparing the errors and warnings of the base revision and the errors and warnings of the current revision, code changes program 180 determines errors and warnings contributed during the current revision, as well as errors and warnings resolved during the current revision. If a previous error identified in the base revision exists at the same position as a new error or warning that is identified in the current revision, code changes program 180 determines whether an identification of the previous error or an annotation describing the code's activity corresponding to the previous error, matches the identification or annotation of the new error or warning. If the compared errors match, code changes program 180 considers the errors to be the same, passed forward from the base revision. If the compared errors or warnings do not match, code changes program 180 considers the previous error removed, and a new error or warning added. If a new error is unable to be compared to a previous error, code changes program 180 considers it to be new. If a previous error is found and is not compared to a new error at the same position, code changes program 180 tags the previous error. Code changes program 180 checks previous errors and considers untagged, previous errors as removals of the previous error resulting from modifications made during development activity of the current revision.

Having determined the errors and warnings associated with the current revision, and having compared the base errors and warnings to the current revision errors and warnings, code changes program 180 determines errors and warnings attributable to the current revision (step 250). Code changes program 180 associates the new errors and warnings, and the removed errors and warnings, with the current revision. In some embodiments of the present invention, the resulting differences are displayed to a user of a computing device, such as a user of computing device 110, creating the current revision within integrated development environment 170. The differences may be displayed as a list of additional and removed errors and warnings. For example, a list of additional and removed errors and warnings shown to a user may appear as:

Removed warning at file.c:110 unused variable example

New error at file.c:120 unknown variable badname

In other embodiments, the resulting differences may alternatively be stored in revision repository 140, for example, or stored locally on computing device 110. In yet other embodiments, the resulting differences may be both displayed and stored. Having determined error and warnings corresponding to the current revision, and those corresponding to the base revision, code changes program 180 ends.

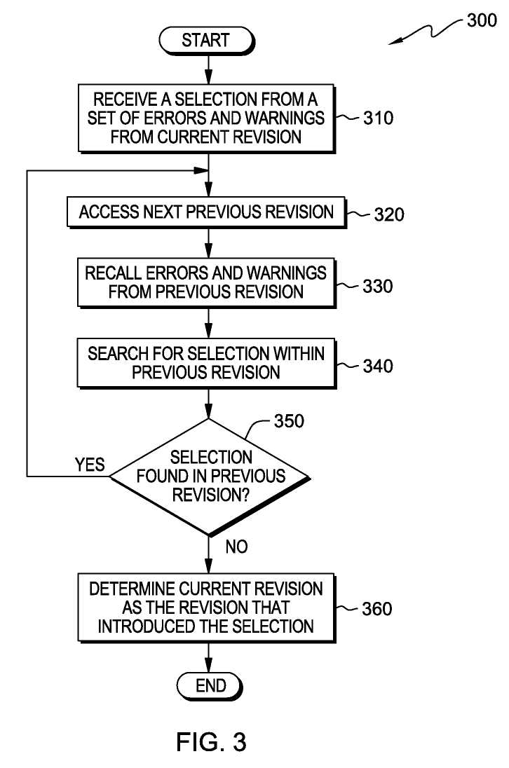

FIG. 3 is a functional block diagram illustrating operational process workflow 300 of code changes program 180 that determines the revision to which an error or warning corresponds, operating on server 160, within the distributed computer processing environment 100 of FIG. 1, in accordance to an embodiment of the present invention.

In one embodiment of the present invention, in which a user wishes to determine the revision that introduced an error or warning, code changes program 180 receives a selection from a set of errors and warnings of the current revision of the source code (step 310). In some embodiments of the present invention, the selection from the set of errors and warnings is made by a user; whereas, in other embodiments, the selection is made by an automated process used to assign errors and warnings to particular revisions of source code. The current set of errors and warnings included in the current revision may be generated by a compiler or another static code analysis tool.

In some embodiments of the present invention, if an error or warning is selected from a particular revision, code changes program 180 searches errors or warnings from previous revisions to determine in which revision the error or warning is initially observed (which revision introduced the error or warning). For example, code changes program 180 receives a selection from a set of errors and warnings, hereafter referred to as “the selection”, to determine in which revision the selection was introduced during development activity. Having received the selection of an error or warning from a current revision, code changes program 180 may store the selected error and its associated attributes, such as, the source file name, the line number associated with the error, the character position within the line number, an identification of the error, and an annotation describing the code's activity corresponding to the error or warning in revision repository 140.

Code changes program 180 accesses the next previous revision of the source code, (step 320). In an embodiment of the present invention, the previous revision is accessed from revision repository 140. For example, a user has selected “error 123” from the errors and warnings view of the most recent revision of code, current revision 5. Code changes program 180 accesses the next previous revision of source code, revision 4.

Code changes program 180 recalls the set of errors and warnings from the previous revision (step 330). The set of errors and warnings of revision 4 may include the cumulative errors and warnings of revision 4 and errors and warnings from previous revisions that have not been resolved. For example, code changes program 180 determines errors on a previous revision of code, revision 4, by distinguishing the attribute information of each error generated in revision 4, or included in revision 4 by remaining unresolved from previous revisions, such as revision 3. Attributes of an error or warning may include one or a combination of: a source code file name, a line number, and a character number within the line number, an identification of the error or warning, and an annotation describing the code's activity corresponding to the error or warning identifying text. Code changes program 180 may determine errors and warnings of a previous revision of source code using a combination of the information attributes. In some embodiments of the present invention, code changes program 180 stores the previous errors and warnings, and their respective positions and attributes, in revision repository 140. In other embodiments, code changes program 180 stores the errors and warnings and their corresponding attributes locally.

To map errors and warnings from the previous revision of code, code changes program 180 tracks any line additions, removals, or changes to the previous revision based on how the current revision may have changed. A file difference generator, such as a diff utility, may be used to compare different sources of text in the revisions. Code changes program 180 estimates and records the expected position of previous errors or warnings based on additional lines of code that were added or lines of code removed in the current revision of code. The expected positions of the errors and warnings of previous revisions are tagged or marked. In an embodiment of the present invention, code changes program 180 stores the expected error or warning positions of the previous revision in revision repository 140, including the tagging or marking of expected error and warning positions.

Having stored the selection and the previous errors and warnings along with the expected locations of the previous errors and warnings in revision repository 140, code changes program 180 searches for the selection within the previous revision (step 340). Code changes program 180 searches to determine whether the selection is found within the previous markers (previous errors and warnings) of the previous revision. Code changes program 180 performs the search based on the attributes of the selection and the attributes of the previous markers, such as the source file name and the expected location of the error or warning, the expected location including the line number, and character position within the line number.

Code changes program 180 compares the differences between the attributes of the selection and the attributes of the previous marker to determine if the selection is found in the previous revision (decision step 350). If the selection exists at the same position of a previous marker, code changes program 180 determines if an identification of the selection, or an annotation describing the code's activity corresponding to the selection, matches the identification or annotation of the previous marker. For example, the selection error may be “unused variable foo.” If the text of the previous marker associated with a previous error is also “unused variable foo,” then the previous marker and the selection match. If the selection and the previous marker match, code changes program 180 determines the selection to be found in the previous revision (step 350, “YES” branch) and accesses the next previous revision (return to step 320) from revision repository 140, to continue the determination of which revision introduced the selection error or warning. The “next previous revision” becomes the “previous revision,” and the former previous version becomes the “current revision.” Code changes program 180 then proceeds as described above to determine if the selection is found in the newly established previous revision.

For the case in which the selection and previous marker from the errors and warnings of the previous revision, do not match, code changes program 180 determines that the selection is not found in the previous revision (step 350, “NO” branch) and considers the currently selected revision as the revision that introduced the selection (step 360). In an embodiment of the present invention, for the case in which a previous marker is located in the previous version at the expected location of the selection, but the previous marker does not match the selection, code changes program 180 considers the previous marker to be present in the previous revision and removed in the current revision. Code changes program 180 determines the selection (of error or warning) to be introduced at the same location within the code of the current revision as an added error or warning. For example, if the selection is “unused variable foo” and is not found in the previous revision, and the previous marker is “unmatched quote,” and is present in the previous revision, at the expected location of the selection, “unused variable foo”, code changes program 180 considers the previous marker, “unmatched quote” removed, and the selection, “unused variable foo”, added in the current revision as an additional error or warning. In another embodiment of the present invention in which the selection is not found in the previous revision, and a previous marker is missing in the previous revision, code changes program 180 considers the error or warning found in the current revision to be a new error or warning. For example, if the selection, “unused variable foo,” is not found in the previous revision and a previous marker for “unused variable foo” is missing in the previous revision, code changes program 180 may consider “unused variable foo” a new marker.

Having determined that the selection is not found in the previous revision code changes program 180 determines that the current revision introduced the selection (step 360). In some embodiments of the present invention, code changes program 180 records the selection and the revision in which the selection was introduced, and stores the information in revision repository 140, and displays the information assigning the selection from the set of the errors and warnings to correspond to the current revision, and code changes program 180 ends. In other embodiments, code changes program 180 records the information identifying the revision in which the selection was introduced, but does not display the information assigning the selection from the set of errors and warnings to the corresponding revision. In yet other embodiments, code changes program 180 displays the information assigning the selection to the corresponding revision in which the selection was introduced, but does not record the information.

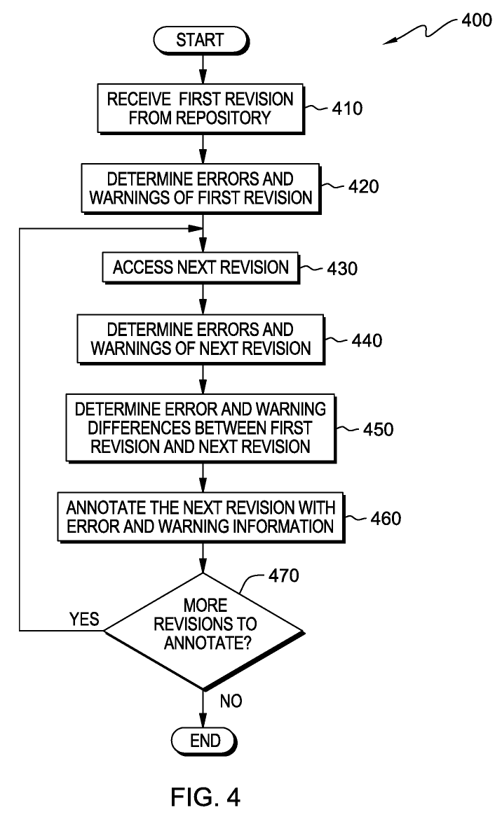

FIG. 4 is a functional block diagram illustrating operational process workflow 400 of code changes program 180 for annotating revision history with error and warning information, operating on server 160 within distributed computing environment 100 of FIG. 1, in accordance to an embodiment of the present invention. In an embodiment of the present invention, operational process workflow 400 of code changes program 180, illustrates the steps in which a history of source code revisions is annotated with error and warning information. Repository history is annotated by code changes program 180 by iteratively comparing the errors and warnings of a revision to the errors and warnings of the adjacent, subsequent revision, beginning with the first revision. In some embodiments, a first revision is the initial source code that includes errors and warnings that were not resolved. In other embodiments, revision history may be annotated by iteratively comparing the errors and warnings of a revision to the errors and warnings of an adjacent previous revision, beginning with the most recent revision as the base code. In some embodiments of the present invention, one revision of the source code is discernable from another revision, within a view of errors and warnings of an IDE, based on the generation of annotations regarding the errors and warnings introduced and removed by a revision of the source code.

Code changes program 180 receives a first revision from the repository (step 410). For brevity and convenience, embodiments of the present invention perform annotation of the repository history by starting with the oldest revision of source code, referred to as the first revision, and comparing the first revision to a subsequent or next revision with changes attributed to the modifications made during the next revision. Similar results may be obtained by selecting a most current revision and comparing the errors and warnings of the most current revision to an adjacent previous revision, and attributing changes to modifications made during the current revision.

Having received a first revision from the repository, code changes program 180 determines the errors and warnings of the first revision (step 420). To determine the errors and warnings of the first revision, a compiler or another static code analysis tool generates the errors and warnings information associated with the first revision. In some embodiments of the present invention, code changes program 180 determines other tagging mechanisms, for example, use of tags, such as TODO or FIXME, and other annotations, in the first revision; however, for brevity and convenience, embodiments of the present invention, hereafter, refer to errors and warnings to include other tagging or marking mechanisms generated in source code revisions. Code changes program 180 may identify the first revision errors and warnings using their associated attributes, such as the source file, line number, character number within its line number, an identification of the error, or an annotation describing the code's activity corresponding to the error or warning identifying text. Code changes program 180 may determine first revision errors and warnings using a combination of the errors and warnings information attributes. In some embodiments of the present invention, code changes program 180 stores the first revision errors and warnings and their respective positions in revision repository 140. In other embodiments, code changes program 180 stores the first revision errors and warnings locally.

Having stored the first revision errors and warnings, code changes program 180 accesses the next revision of source code (step 430). In some embodiments of the present invention, revisions of the source code, including the revision adjacently subsequent to the first revision, which is referred to as the “next revision” in the current discussion, is accessed from revision repository 140. To map the first revision errors and warnings, code changes program 180 tracks line additions, line removals, and editing changes made to the first revision based on how the next revision may have changed. A file difference generator, such as a diff tool, may be used to compare differences of text between revisions. Code changes program 180 estimates and records the expected locations of the first revision errors and warnings carried over to the next revision of the source code from the first revision, based on the additional lines of code that were added, or lines of code removed, in the next revision. The expected locations of the errors and warnings from the first revision are tagged or marked. In an embodiment of the present invention, code changes program 180 stores the expected locations of errors and warnings of the first revision in revision repository 140.

As a result of a compiler or another static code analysis tool operating on the source code, errors, warnings, or other tagging information of the next revision may be generated, and code changes program 180 determines errors and warnings of the next revision (step 440). Code changes program 180 may determine errors and warnings of the next revision by distinguishing the attribute information of each error and warning generated in that revision. An attribute of an error or warning may include a source file, line number, character number within its line number, an identification of the error, or an annotation describing the code's activity corresponding to the error or warning identifying text. Code changes program 180 may determine errors and warnings of the next revision using a combination of the error, warning, or other information attributes. In some embodiments, code changes program 180 stores the errors and warnings of the next revision and their corresponding locations within the source code of the next revision in revision repository 140. In other embodiments, the errors and warnings and their corresponding locations are stored locally.

Having accessed the errors and warnings of the next revision, code changes program 180 determines error and warning differences between the first revision and next revision (step 450). Code changes program 180 identifies the error and warning differences between the first revision and the error and warnings of the next revision by comparing instances of errors and warnings to determine those that match, and those that do not match, between the two revisions. The attributes of the errors and warnings, such as source files and expected position, including line numbers and character position within their line number, are used by code changes program 180 to determine matching errors and warnings between the first revision and the next revision. For the case in which an error or warning at a particular location in the first revision of source code (referred to herein as a first marker) appears to correspond to an error or warning at the same location within the next revision of the source code (referred to herein as a next marker), code changes program 180 determines if an identification of the first marker, or an annotation describing the code's activity corresponding to the first marker, matches the identification or annotation of the next marker of the next revision. If the compared markers match, code changes program 180 considers the markers to be the same, and the same error or warning exists in both the first revision and the next revision.

If the compared markers do not match, code changes program 180 concludes that the first marker is not found in the next revision and that the next marker found at the particular location within the next revision corresponds to a new error or warning generated during the development activity of the next revision. If a next marker is unable to be compared to a first marker, code changes program 180 considers the next marker to correspond to a new error or warning introduced in the next revision. If a first marker is found in the first revision and not found at the expected location in the next revision, and no matching next marker is found at the same expected location in the next revision, code changes program 180 considers the first marker from the first revision to be removed from the next revision.

Having determined error and warning differences between the first revision and next revision of the source code, code changes program 180 annotates the next revision with error and warning information (step 460). In one embodiment of the present invention, code changes program 180 annotates the next revision by including the error and warning information attributable to the next revision of source code, and aligning the error and warning information with the next revision in a revision history view of an IDE, such as integrated development environment 170. In some embodiments, code changes program 180 displays the differences between the first revision and next revision alongside the row of the next revision in the history view of integrated development environment 170. In other embodiments, a history view of integrated development environment 170 is a list of revisions and corresponding annotations in the repository history view. In yet other embodiments, the differences between the first revision and next revision can be annotated in a description or summary format.

Having annotated the next revision with error and warning information, code changes program 180 determines whether there are more revisions to annotate (decision step 470). If code changes program 180 determines that there are more revisions to annotate (step 470, “YES” branch), code changes program 180 assigns the current “next revision” as the first revision, proceeds to access the revision subsequent to the current “next revision” (return to step 430), assigns the subsequent revision as the next revision, and proceeds as described above. If code changes program 180 determines that there are no more revisions to annotate (step 470, “NO” branch), code changes program 180 ends.

FIG. 5 is a block diagram of components of computing device 501, capable of operating code changes program 180, in accordance with an embodiment of the present invention. It should be appreciated that FIG. 5 provides only an illustration of one implementation and does not imply any limitations with regard to the environments in which different embodiments are implemented. Many modifications to the depicted environment may be made.

Computing device 501 of System 500, server 160, computing device 110, revision repository 140, and integrated development environment 170 include communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Code changes program 180 is stored in persistent storage 508 for execution by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of distributed computer processing environment 100. In these examples, communications unit 510 includes one or more network interface cards. Communications unit 510 may provide communications through the use of either or both physical and wireless communications links. Code changes program 180 may be downloaded to persistent storage 508 through communications unit 510.

I/O interface(s) 512 allows for input and output of data with other devices that may be connected to computing device 501, server 160, computing device 110, revision repository 140, and integrated development environment 170. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., code changes program 180, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for tracking errors and warnings associated with a revision of source code, the method comprising:
one or more computer processors receiving a first revision of a source code and a second revision of the source code, wherein the second revision follows the first revision of the source code, and the first revision of the source code includes annotations that are text descriptions of changes made to the source code;
one or more computer processors mapping a location of each of a first set of errors and warnings included in the first revision of the source code, and a second set of errors and warnings included in the second revision of the source code, wherein errors and warnings are generated during a compiling of a respective revision of the source code;
one or more computer processors generating annotations for the second revision of the source code, wherein the annotations include a text description of changes made to the second revision of the source code, based on the errors and warnings appearing in the second revision of the source code and absent in the first revision of the source code, and errors and warnings absent in the second revision of the source code and present in the first revision of the source code;
one or more computer processors distinguishing the second revision of the source code from the first revision of the source code based, at least in part, on annotations generated for a summary of errors and warnings of the second revision of the source code and annotations generated for a summary of the errors and warnings of the first revision of the source code;
one or more computer processors determining a first set of errors and warnings included in the first revision of the source code;
one or more computer processors determining a second set of errors and warnings included in the second revision of the source code;
one or more computer processors identifying a third set of errors and warnings that appear in the first revision of the source code, and are absent in the second revision of the source code;
one or more computer processors identifying a fourth set of errors and warnings that are absent in the first revision of the source code, and that appear in the second revision of the source code, wherein each error and warning of the first set of errors and warnings, the second set of errors and warnings, the third set of errors and warnings, and the fourth set of errors and warnings include one or more attributes corresponding to a particular revision of the source code, and wherein an attribute of the one or more attributes is one of: a file name of the source code, a line number, a character position within the line number, an identification code of the error or warning, a label of the error or warning, or an annotation as a description of the code's activity corresponding to the error or warning as identifying text; and
one or more computer processors generating a combination of the third set of errors and warnings and the fourth set of errors and warnings as a summary of introduced and removed errors and warnings respectively, which correspond to the second revision of the source code.
